(19) United States
(12) Patent Application Publication
(10) Pub. No.: US 2002/0122142 A1
(43) Pub. Date: Sep. 5, 2002

(54) Apparatus and method for enhancing image resolution by position perfurbation modulation

(75) Inventor: Yao-Min Lin, Hsinchu (TW)

Correspondence Address: LADAS & PARRY, 26 WEST 61ST STREET, NEW YORK, NY, 10023, US

(73) Assignee: INDUSTRIAL TECHNOLOGY RESEARCH INSTITUTE

(21) Appl. No.: 09/845,434

(22) Filed: Apr. 30, 2001

(30) Foreign Application Priority Data
Dec. 30, 2000 (TW) 89128409

(51) Int. Cl. H04N 5/74

(52) U.S. Cl. 348/785; 348/781

(57) ABSTRACT

The present invention provides an apparatus and method for enhancing image resolution by a position perfurbation modulation which changes optical imaging paths by a rotatable wedge lens turntable. The imaging positions on an image detector is periodically changed so as to obtain the effect of the displacement disturbance and to breach the resolution limitation of the image detector. The present invention could further cooperate with the design of an optical imaging system and image processing to increase the image resolution and detect where a questionable pixel situates.

### BACKGROUND OF THE INVENTION

1. Field of the Invention

The present invention relates to an apparatus and method for enhancing image resolution, and particularly to an apparatus and method for enhancing image resolution by a position perfurbation modulation.

2. Description of Related Art

In general, image resolution is usually limited by pixel numbers of an image detector, design of an optical imaging system, spaces of optical paths, quality of imaging and even diffraction limitation of an optical system.

In other words, the diffraction limitation is usually the barrier of the imaging technology, and a high-resolution image detector is so expensive that would not be used popularly.

As technology progresses, the requirement of a high-resolution image detector in nowadays is greater than beforetime, and it is necessary to design a low cost and high-resolution image detector.

### SUMMARY OF THE INVENTION

One object of the present invention is to provide a low cost and high-resolution image capture apparatus and method. For achieving the above object, the present invention provides an apparatus and method for enhancing image resolution by a position perfurbation modulation which changes optical imaging paths by a rotatable wedge lens turntable. The imaging position on an image detector is periodically changed so as to obtain the effect of the displacement disturbance and to breach the resolution limitation of the image detector. The present invention could further cooperate with the design of an optical imaging system and image processing to increase the image resolution and detect where a questionable pixel situates.

The present invention provides an easier, cheaper and simpler method to greatly raise the image resolution and to save the cost of using an expensive high-resolution image detector. Besides, the present invention could also be used to detect questionable pixels on a planar display (CRT, LCD or OLED) or execute an automatic optical detection during a semiconductor packaging process.

### BRIEF DESCRIPTION OF THE DRAWINGS

The present invention will be described according to the appended drawings in which:

FIG. 1 shows an apparatus for enhancing image resolution by a position perfurbation modulation of the present invention;

FIG. 2 shows a rotatable wedge lens turntable of the present invention; and

FIGS. 3(a)˜(f) show schematic diagrams of processing models of the position perfurbation modulation of the present invention.

### PREFERRED EMBODIMENT OF THE PRESENT INVENTION

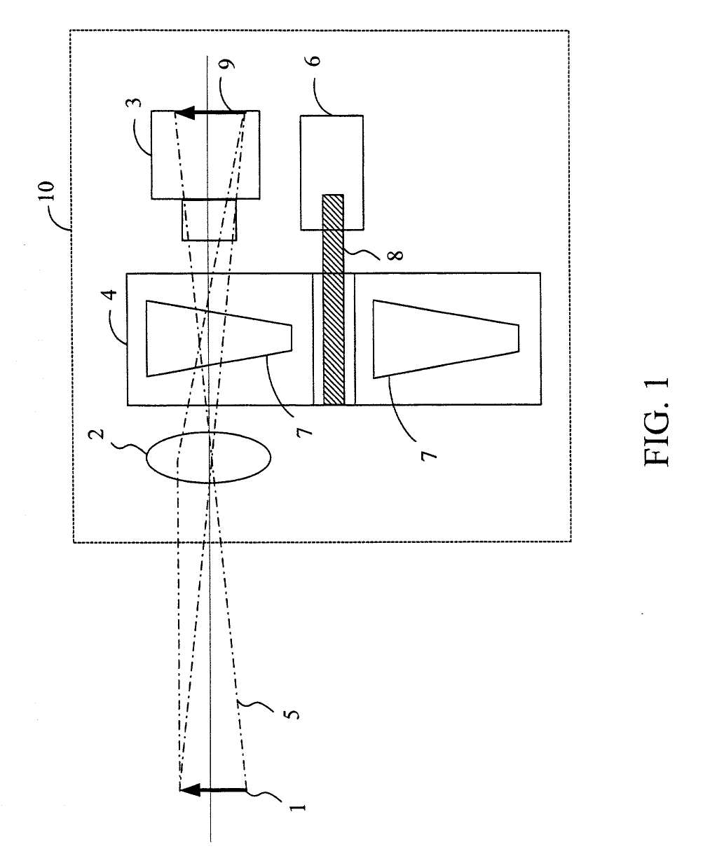

FIG. 1 shows an apparatus for enhancing image resolution by a position perfurbation modulation of the present invention. The apparatus comprises an optical lens assembly 2, a wedge lens turntable 4, a step motor 6 and an image detector 3, such as a capacitance-coupling device. The wedge lens turntable 4 is an important characteristic of the present invention. It has five holes along the circumference, four wedge lenses 7 with different imaging functions filling in four holes and leaving one hole empty. The wedge lens turntable 4 has a hollow region, a shaft 8 whose one end is controlled by the step motor 6 is placed in the hollow region, and the step motor 6 controls the rotating speed of the wedge lens turntable 4. The wedge lenses are embedded in the wedge lens turntable 4. Each lens projects an image of an object 1 into an imaging position 9 on the image detector 3 so as to generated periodic movements like a displacement disturbance.

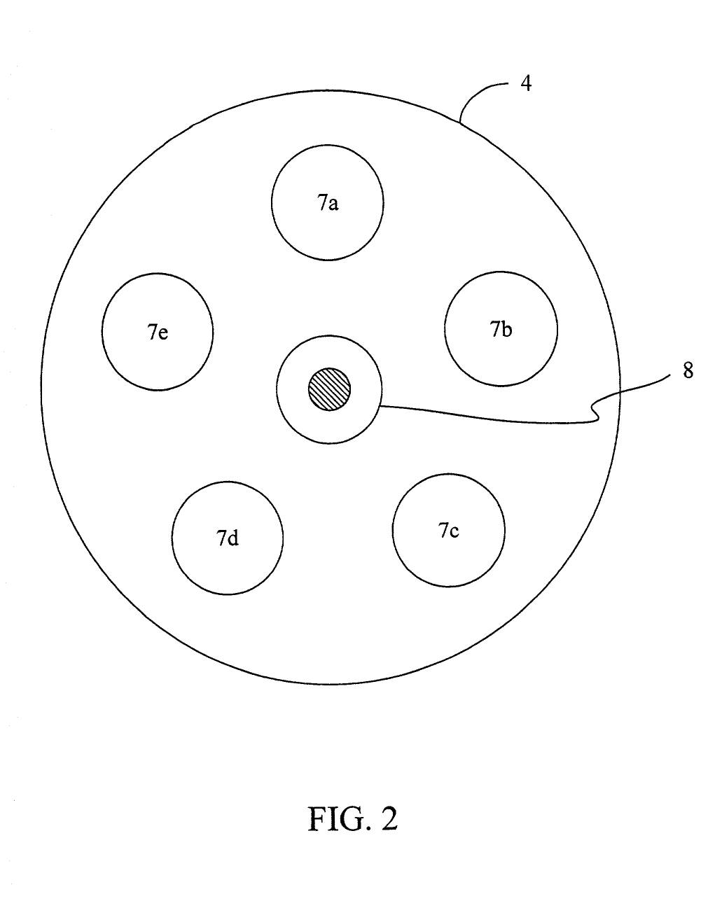

FIG. 2 shows a rotatable wedge lens turntable 4 of the present invention. The rotatable wedge lens turntable 4 has a through hole 7a and four holes having wedge lenses 7 with different imaging functions placed along the circumference of the wedge lens turntable 4. The four wedge lenses 7 include a wedge lens 7b which shifts an image upward, a wedge lens 7c which shifts an image leftward, a wedge lens 7d which shifts an image downward and a wedge lens 7e which shifts an image rightward. When an optical imaging path passes through the through hole 7a, the imaging position on the image detector 3 is not shifted. But when the optical imaging path passes through the wedge lenses 7b˜7e, the imaging positions on the image detector 3 are shifted to neighboring positions (i.e., up, left, down and right respectively). The wedge lens turntable 4 has a hollow region, a shaft 8 whose one end is controlled by the step motor 6 is placed in the hollow region, and therefore the step motor 6 can control the rotating speed of the rotatable wedge lens turntable 4.

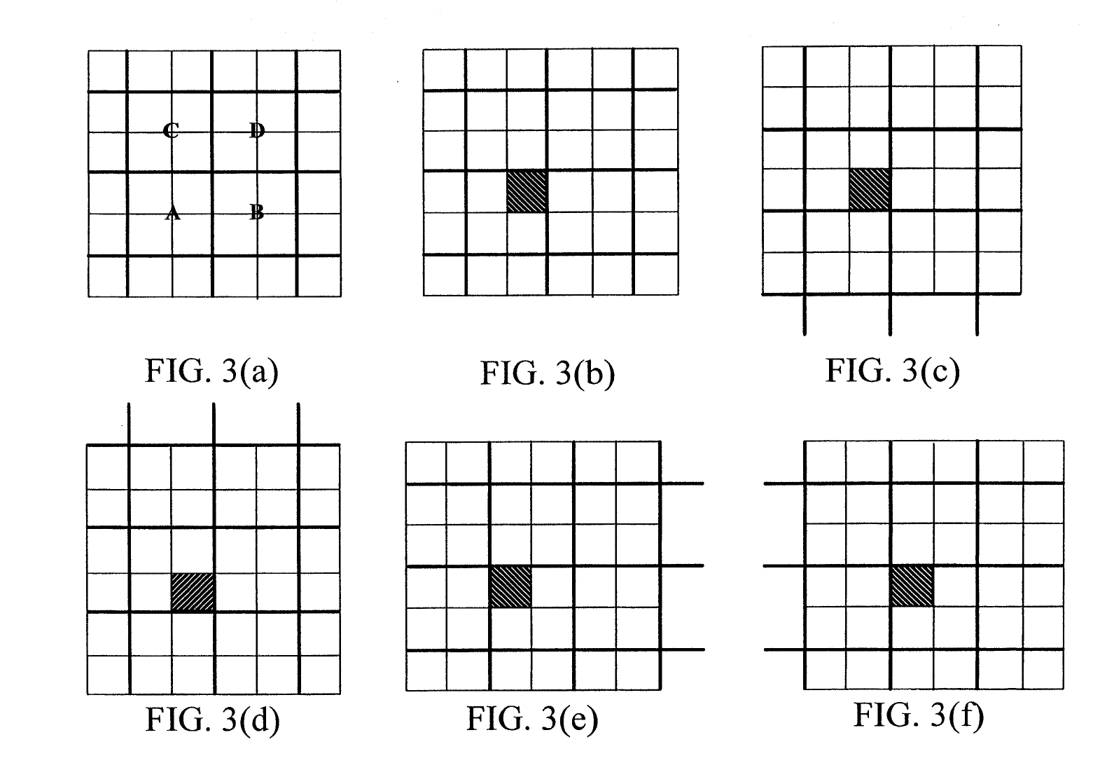

FIGS. 3(a)˜(f) show schematic diagrams of processing models of the position perfurbation modulation according to the present invention. Supposing that a pixel of an object 1 has an 2×2 resolution, a pixel of the image detector 3 has a 1×1 resolution; in other words, the resolution of the object is larger than that of the image detector 3. The positions of pixels A, B, C and D of the image detector 3 are shown in FIG. 3(a). In FIG. 3(b), an object pixel (black dot) can be captured by the pixel A of the image detector 3. But if we exclude the pixel corresponding to the object pixel (black dot), the pixel number inside the pixel A is 3, the pixel number inside the pixel B is 4, the pixel number inside the pixel C is 4, and the pixel number inside the pixel D is 4. If we shift the imaging position on the image detector 3 upward a distance of one object pixel, shown as FIG. 3(d), the pixel number inside the pixel A is 3, the pixel number inside the pixel B is 4, the pixel number inside the pixel C is 4, and the pixel number inside the pixel D is 4. If we shift the imaging position on the image detector 3 rightward a distance of one object pixel, shown as FIG. 3(e), the pixel number inside the pixel A is 3, the pixel number inside the pixel B is 4, the pixel number inside the pixel C is 4, and the pixel number inside the pixel D is 4. If we shift the imaging position on the image detector 3 leftward a distance of one object pixel, shown as FIG. 3(f), the pixel number inside the pixel A is 4, the pixel number inside the pixel B is 3, the pixel number inside the pixel C is 4, and the pixel number inside the pixel D is 4. The above results can be organized as follows:

TABLE 1

| | Pixel number | Pixel number | Pixel number | Pixel number |
|---|---|---|---|---|
| | inside | inside | inside | inside |
| | pixel A | pixel B | pixel C | pixel D |
| Zero | 3 | 4 | 4 | 4 |
| displacement | | | | |
| Upward | 4 | 4 | 4 | 3 |
| displacement | | | | |
| Downward | 3 | 4 | 4 | 4 |
| displacement | | | | |
| Leftward | 3 | 4 | 4 | 4 |
| displacement | | | | |
| Rightward | 4 | 3 | 4 | 4 |
| displacement | | | | |

It can be known from the field of zero displacement in Table 1 that one of the four pixels is questionable in pixel A, but which pixel is bad is unknown. Pixels B, C and D are all good pixels. Table 2 is obtained by subtracting the pixel number in the field of zero displacement from the pixel number in the fields of other directions. Since Δright and Δup in field A is +1, it can be predicted that the questionable pixel situates in the right upper corner of field A.

TABLE 2

| Pixel position | A | B | C | D |
|---|---|---|---|---|
| Δright | 1 | −1 | 0 | 0 |
| Δleft | 0 | 0 | 0 | 0 |
| Δup | 1 | 0 | 0 | −1 |
| Δdown | 0 | 0 | 0 | 0 |

Supposing that the object pixel is located at a different imaging position on the image detector 3, we can repeat the above procedures to obtain corresponding tables. According to the data of the tables, the position of any object pixel can be known by a position perfurbation modulation such that possible questionable pixels in the image detector can be found.

The above-described embodiments of the present invention are intended to illustrate only. Numerous alternative embodiments may be devised by those skilled in the art without departing from the scope of the following claims.

What is claimed is:

1. An apparatus for enhancing image resolution by a position perfurbation modulation, comprising:
an optical lens assembly;
a wedge lens turntable embedded with a plurality of wedge lenses for projecting images passing through the optical lens assembly;
a step motor for rotating the wedge lens turntable; and
an image detector for capturing the projected image passing through the wedge lens turntable.

2. The apparatus of claim 1, wherein the wedge lenses shift images upward, leftward, downward and rightward.

3. The apparatus of claim 1, wherein the wedge lenses and a through hole are placed along the circumference of the wedge lens turntable.

4. The apparatus of claim 1, wherein the wedge lens turntable has a hollow region for receiving a shaft whose one end is controlled by the step motor.

5. The apparatus of claim 1, wherein the image detector is a capacitance-coupling device.

6. A method for enhancing image resolution by a position perfurbation modulation, comprising the following steps:
(a) utilizing an image detector to capture projected images passing through wedge lenses which shift images upward, downward, rightward and leftward and a through hole;
(b) computing pixel numbers captured by the image detector via the through hole and the wedge lenses, and subtracting the pixel number obtained from the through hole from the pixel numbers obtained from the wedge lenses respectively; and
(c) determining a position of a questionable pixel according to the above computation and a predefined table.
